(19) United States
(12) Patent Application Publication
(10) Pub. No.: US 2001/0011559 A1
(43) Pub. Date: Aug. 9, 2001

(54) Electro-hydraulically operated control valve with a polarised switching magnet

(76) Inventor: Hans-Udo Rheiner, Menden (DE)

Correspondence Address: Daniel C. McEachran, COOK,ALEX, MC FARRON, MANZO,CUMMINGS & MEHLER, LTD, Suite 2850, 200 West Adams Street, Chicago, IL, 60606, US

(21) Appl. No.: 09/733,193

(22) Filed: Dec. 8, 2000

(30) Foreign Application Priority Data
Dec. 14, 1999 (DE) 199 59 332.9

(51) Int. Cl. F15B 13/044

(52) U.S. Cl. 137/625.65

(57) ABSTRACT

An electro-hydraulic control valve for an hydraulic self advancing support, comprising a 3/2-way valve (11) which can be connected to a high pressure line and a direct current magnet (12) for the control of the control valve, a permanent magnet (22) provided to hold a switching pin (20) in its switched position, and an electronic controller for reversing the polarity of the direct current magnet (12) to control the reversal of the directional control valve (11).

The present invention relates to an electro-hydraulic control valve for an hydraulic self advancing support, comprising a 3/2-way valve which can be connected to a high pressure line, and a direct current magnet, controlled by an electronic controller, which can be connected to an intrinsically safe power supply for the control of the 3/2-way valve between a closed position defined by the influence of spring pressure and/or standing fluid pressure and an open position established by the movement of a switching pin from its starting position to its switched position by the direct current magnet and maintained by the switching pin in the open position.

A directional control valve of this construction is described in DE 196 46 611 A1; the control valve is set into a valve casing, with the valve including connections to a tank, to a pump and to a user, and a closing element is provided, which is held on its seating in its closed position by a valve spring and by standing fluid pressure and is pre-tensioned in its closed position. A direct current magnet is provided to control the movement of the directional control valve to its open position, which comprises an iron core, a cylindrical coil element and an internal armature. On energising the direct current magnet with an applied voltage, the armature, and therewith a switching pin connected to it, is moved in the direction of the directional control valve, whereby the movement of the switching pin is transmitted to the closing element and moves it into the open position of the directional control valve to the user. As long as the energising of the direct current magnet is maintained, the directional control valve remains in this switched position open to the user; when the current to the direct current magnet is switched off, the valve spring and the standing fluid pressure ensure the return or reversal of the closing element to its closed position.

A disadvantage associated with this control valve is that electrical power has to be provided, apart from for the control of the valve, for maintaining the switched position in the open phase of the valve. Since in the current concentrations of operating devices at individual operating points a large number of control valves of this construction are used, significant installation and operating costs result in spite of the comparatively low consumption of electrical power of the control valve. It is also possible that in the event of failure of the power supply the control valves automatically revert to their closed positions, which can be undesirable depending on the individual operating situation.

An aim of the present invention is therefore to provide a control valve with reduced electrical power requirements.

Accordingly, the invention to directed to an electro-hydraulic control valve as described in the opening paragraph, and further comprising a permanent magnet to hold the switching pin in its switched position, and an electronic controller for reversing the polarity of the direct current magnet depending on the controlled resetting of the directional control valve, being arranged in such a manner that for the control of the directional control valve to its open position the same polarity of the permanent magnet and the direct current magnet can be selected, and for the control of the directional control valve to its closed position opposing polarity of the permanent magnet and direct current magnet can be selected.

This offers the advantage that for the maintenance of the open position of the Calve the power supply to the direct current magnet can be reduced and possibly switched off altogether, since the integrated permanent magnet takes over the maintenance of the switching pin in its position effecting and maintaining the open position of the directional control valve. To effect the reversal of the directional control valve from one operating position to the other, the polarity of the direct current magnet is reversed. The control electronics are thus designed to direct the polarity of the direct current magnet to be in the same sense as that of the permanent magnet for the movement of the switching pin into the position effecting the opening of the directional control valve, so that the lines of force of the permanent magnet and the direct current magnet run in the same sense and the standing magnetic field of the permanent magnet is strengthened. Because of the magnetic field generated in this manner the armature is pulled in and the switching pin is moved into its position effecting the valve opening; in this final position the armature is held exclusively by the permanent magnet, so that-according to the strength of the permanent magnet-the energising of the direct current magnet can be significantly reduced or the power supply to the direct current magnet can even be switched off completely. If the directional control valve is to be returned to its closed position, the polarity of the direct current magnet is directed in the opposite sense to the polarity of the permanent magnet, so that the lines of force of the permanent magnet and the direct current magnet run in opposing sense and thereby the field strength of the permanent magnet is weakened; the permanent magnet can no longer hold the armature with the switching pin in its switched position, so that the valve spring and/or the standing fluid pressure effect the return of the closing element of the valve into its closed position.

Advantageously, the permanent magnet is arranged on the end of a cylindrical coil element of the direct current magnet adjacent to the directional control valve, axial with the coil element or alternatively enclosed by the coil element in an annular space between the coil element and the switching pin; in the latter embodiment a reduction in the assembled size of the control valve results.

As on the one hand, the invention is advantageous in that a failure of the power supply to the direct current magnet does not lead to an automatic closure of the control valve, and on the other hand, energising of the direct current magnet is necessary to transfer the control valve into its closed position, preferably a switchable energy store is provided for use in the direct current magnet for use in the event of failure of its power supply.

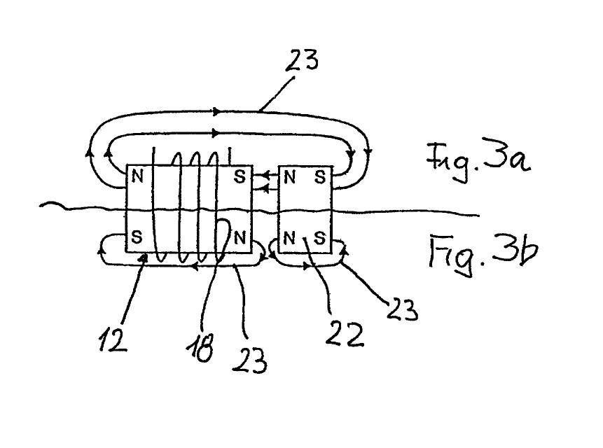

Examples of the present invention will now be described with reference to the accompanying drawings, in which:

| | |
|---|---|
| | shows a longitudinal sectional view |
| | of a first embodiment of an electro- |
| | hydraulic control valve in accordance |
| | with the present invention; |
| | shows a longitudinal sectional view |
| | of a second embodiment of such an |
| | electro-hydraulic control valve; and |
| Figures 3a and 3b | show a schematic representation of |
| | the arrangement of the polarity of a |
| | direct current magnet and a permanent |
| | magnet for various switching |
| | processes of a control valve |
| | according to the invention. |

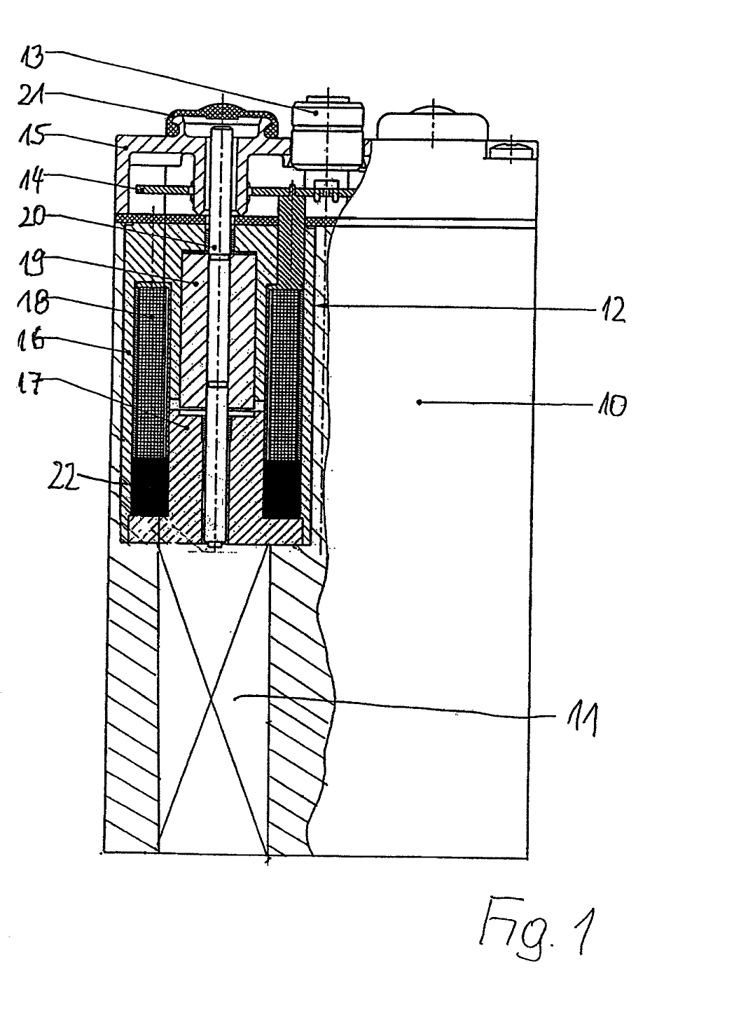

FIG. 1 shows only the components required for the control of a directional control valve; the construction of a 3/2-way valve 11 with its associated hydraulic connections within a valve casing 10 is without relevance to the present invention and is described in detail in DE 196 46 611 A1.

Two valves 11 are arranged alongside each other in the valve casing 10, each directional control valve 11 having a direct current magnet 12. The two direct current magnets 12 of the control valves are connected by means of a plug connector 13 to an intrinsically safe power supply (not shown). The plug connector 13 is assembled into a circuit board 14 with inserted diodes, which covers both direct current magnets 12 in a horizontal position and is accommodated in a casing cover 15 closing the top of the valve casing 10.

The individual direct current magnets 12 each comprise a cover 16, an iron core 17, a cylindrical coil element 18 and an internal armature 19. By energising the direct current magnet 12 with an applied-current with the appropriate polarity of a permanent magnet 22, to be described later, the armature 19 is moved in an axial direction towards the directional control valve 11. A switching pin 20 is connected to the armature 19, which transmits the switching force of the direct current magnet 12 to the directional control valve 11 housed in the valve casing 10. The length of the switching pin 20 passes through the direct current magnet 12 and the circuit board 14. The top end of the switching pin 20, which emerges from the casing cover 15 and is covered by an elastic bonnet 21, can in an emergency be operated manually to open the directional control valve 11.

In the embodiment shown in FIG. 1 a permanent magnet 22 is arranged in the region of the iron core 17 as an axial extension of the cylindrical coil element 18, whose polarity and interoperation with the direct current magnet 12 in the switching positions of the directional control valve 11 is shown in FIGS. 3a and 3b. As can be seen from FIG. 3a, to move the armature 19 with the switching pin 20 into the open position of the directional control valve 11 (not shown), the direct current magnet 12 is polarised via the electronic control such that the lines of force 23 run through the permanent magnet 22 and the direct current magnet 12 in the same sense, so that the standing magnetic field of the permanent magnet 22 is strengthened. Because of this strengthening of the magnetic field the armature 19, with the switching pin 20, is pulled, in the direction of the directional control valve 11, so that owing to this linear movement a closing element arranged in the directional control valve is driven into the open position for the supply to the user. In this final position bringing about the open position of the directional control valve the armature 19 with the switching pin 20 is held by the permanent magnet 22, so that the current necessary for energising the direct current magnet 12 can be disconnected; in this final position therefore only the permanent magnet 22 operates on the armature 19.

If the directional control valve 11 has to be reconfigured into the closed position by its closing element, the direct current magnet 12 is again energised, with, however, polarity contrary to that of the permanent magnet 22, as is shown in FIG. 3b. The lines of force 23 illustrated therein show that the magnetic field of the permanent magnet 22 is weakened so that the field strength is no longer sufficient to hold the armature 19 with the switching pin 20 in place; a valve spring arranged in the directional control valve 11, possibly supported by the standing pressure of a pressure fluid, moves the switching pin 20 together with the armature 19 back into the starting position shown in FIG. 1.

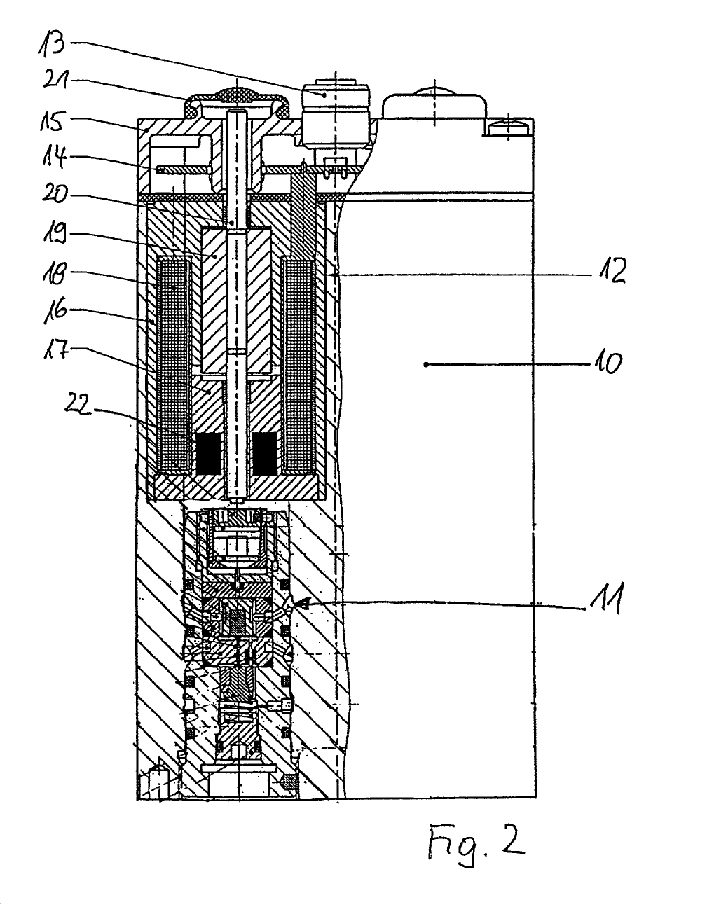

In the embodiment shown in FIG. 2 the permanent magnet 22 is arranged in the annular space between the coil element 18 and the switching pin 20 in the iron core 17 and is thus surrounded by the coil element 18, whereby a reduction in the assembled size of the control valve results.

We claim:

1. An electro-hydraulic control valve for an hydraulic self-advancing support, comprising a 3/2-way valve which can be connected to a high pressure line, and a direct current magnet, controlled by an electronic controller, which can be connected to an intrinsically safe power supply for the control of the 3/2-way valve between a closed position defined by the influence of spring pressure and/or standing fluid pressure and an open position established by the movement of a switching pin from its starting position to its switched position by the direct current magnet and maintained by the switching pin in the open position, and further comprising a permanent magnet to hold the switching pin in its switched position, and an electronic controller for reversing the polarity of the direct current magnet to control reversal of the control valve in such a manner that for movement of the control valve into its open position the polarity of the permanent magnet and the direct current magnet are in the same sense and for the reversal of the control valve into its closed position the polarity of the permanent magnet and the direct current magnet can be set in the opposing sense.

2. A control valve according to claim 1, in which in the switched position of the switching pin corresponding to the open position of the control valve, the current effecting the energising of the direct current magnet is disconnected.

3. A control valve according to claim 1, in which the permanent magnet is arranged on the end of, and axially with a cylindrical coil element of the direct current magnet facing the control valve.

4. A control valve according to claim 1, in which the permanent magnet is arranged at the end of a cylindrical coil element facing the control valve, surrounded by the coil element in an annular space between the coil element and the switching pin.

5. A control valve according to claim 1, in which a switchable energy store is provided for the direct current magnet for use in the event of failure of its power supply.
